(19) United States
(12) Patent Application Publication
(10) Pub. No.: US 2009/0278877 A1
(43) Pub. Date: Nov. 12, 2009

(54) LIQUID EJECTING APPARTAUS AND LIQUID EJECTING METHOD

(75) Inventors: Satoshi KIMURA, Shiojiri-shi (JP); Noriaki YAMASHITA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/437,687

(22) Filed: May 8, 2009

(30) Foreign Application Priority Data
May 9, 2008 (JP) 2008-123778

(51) Int. Cl. B41J 29/38

(52) U.S. Cl. 347/10

(57) ABSTRACT

A liquid ejecting apparatus includes pressure chambers that communicate with nozzles and an element that varies liquid pressure inside the pressure chamber in accordance with variation in a potential. An ejection pulse generating unit generates a first ejection pulse applied to the element upon ejecting first liquid droplets from the nozzles and a second ejection pulse applied to the element upon ejecting subsequent, second ejection droplets. The first ejection pulse excites the liquid inside the pressure chamber to pressure vibration and then allows the element to eject liquid droplets from the nozzles when the pressure of the liquid inside the pressure chamber reaches a predetermined pressure. The second ejection pulse excites the liquid to pressure vibration and then allows the element to eject the liquid droplets from the nozzles at certain time when the pressure of the liquid becomes lower than the predetermined pressure.

### BACKGROUND

1. Technical Field

The present invention relates to a liquid ejecting apparatus and a liquid ejecting method.

2. Related Art

A liquid ejecting apparatus such as an ink jet printer (hereinafter, simply referred to as a printer) uses an ejection pulse. The ejection pulse has a variation pattern of a potential for ejecting liquid droplets from nozzles and is applied to an element performing a process of ejecting the liquid droplets. In such a kind of a liquid ejecting apparatus, when the ink droplets having the same quantity are continuously ejected, the ejection pulses having the same variation pattern of the potential are continuously applied to the element (for example, see JP-A-2002-103619).

A technique for optimizing the variation pattern of the potential on the basis of the flying speed and the weight of a liquid droplet has been suggested. In this technique, the ejection pulses having the same variation pattern of the potential are applied to the element at a constant interval at the time of optimizing the variation pattern of the potential of an ejection pulse (for example, see JP-A-2003-94629).

The number (ejection frequency) of liquid droplets ejected per unit time is determined by an interval at which the ejection pulses are applied to the element. A process such as a printing process can be performed at a high speed, as the ejection frequency is higher. However, when the interval between the ejection pulses is too short, ejection of the liquid droplets may become unstable. For example, a problem occurs in that a flying speed of the liquid droplet is excessively fast or a flying direction of the liquid droplet is not constant. Therefore, in a known liquid ejecting apparatus, the interval (ejection frequency) between the ejection pulses is constant in a range in which the ejection of the liquid droplets is stable.

However, there is a high demand for an improved liquid ejecting apparatus. Moreover, there is a demand for making an ejection frequency high.

### SUMMARY

An advantage of some aspects of the invention is that it provides a liquid ejecting apparatus ejecting liquid droplets stably even when an ejection frequency is increased.

According to an aspect of the invention, there is provided a liquid ejecting apparatus including: pressure chambers which individually communicate with nozzles; an element which performs a process of varying a liquid pressure inside the pressure chamber in accordance with variation in a potential; and an ejection pulse generating unit which generates an ejection pulse having a determined variation pattern of the potential and generates a first ejection pulse applied to the element upon ejecting first liquid droplets from the nozzles and a second ejection pulse applied to the element upon ejecting second ejection droplets subsequent to the first liquid droplet from the nozzles. The first ejection pulse has a first excitation component exiting the liquid inside the pressure chamber to pressure vibration and a first ejection component generated after generation of the first excitation component and allowing the element to perform a process of ejecting liquid droplets from the nozzles at the time when the pressure of the liquid inside the pressure chamber reaches predetermined pressure. The second ejection pulse has a second excitation component exciting the liquid inside the pressure chamber to pressure vibration and a second ejection component generated after generation of the second excitation component and allowing the element to perform the process of ejecting the liquid droplets from the nozzles at certain time while the pressure of the liquid inside the pressure chamber becomes lower than the predetermined pressure.

Other features of the invention are apparent from the specification of the invention and the accompanying drawings.

### BRIEF DESCRIPTION OF THE DRAWINGS

The invention will be described with reference to the accompanying drawings, wherein like numbers reference like elements.

FIG. 1A is a block diagram illustrating the configuration of a printer and FIG. 1B is a conceptual diagram illustrating a storage area of a memory.

FIG. 2A is a sectional view illustrating a head and FIG. 2B is a diagram illustrating a flow passage unit viewed from nozzles.

FIG. 3 is a block diagram illustrating the configuration of a driving signal generating circuit or the like.

FIG. 4 is a diagram illustrating a driving signal.

FIG. 5A is a diagram illustrating a variation pattern of the potential of an ejection pulse and FIG. 5B is an explanatory diagram illustrating a generation period of each component constituting the ejection pulse.

FIG. 6 is an explanatory diagram illustrating an evaluation result and a variation of a normal flying speed of an ink droplet.

FIG. 7 is an explanatory diagram illustrating an ejection pulse group used for evaluation.

FIG. 8A is a diagram illustrating an ejection pulse evaluating apparatus, FIG. 8B is an explanatory diagram illustrating a relation between an ink droplet and a laser beam, and FIG. 8C is an explanatory diagram illustrating variation in an output level of a light-receiving unit.

FIG. 9 is an explanatory diagram illustrating the ejection pulse group used for evaluation when the generation period of a first hold component is made different.

FIG. 10 is a diagram illustrating a relation between the variation of the flying speed of an ink droplet and an interval from an evaluation target ejection pulse to a subsequent ejection pulse.

FIG. 11 is a diagram illustrating the flying speed of the ink droplet when the generation period of a first hold component is made longer gradually.

FIG. 12 is a diagram schematically illustrating flying statuses of ink droplets formed by a previous ejection pulse, ink droplets formed by the evaluation target ejection pulse, and ink droplets formed by the subsequent ejection pulse.

FIG. 13 is an explanatory diagram illustrating an ejection pulse group used for evaluation when the generation period of a first expansion component is made different.

FIG. 14 is a diagram illustrating a relation between the variation of the flying speed of the ink droplets and an interval from the evaluation target ejection pulse to the subsequent ejection pulse.

### DESCRIPTION OF EXEMPLARY EMBODIMENTS

At least the following aspects of the invention are apparent from the description of the specification and the accompanying drawings.

According to an aspect of the invention, there is provided a liquid ejecting apparatus including: pressure chambers which individually communicate with nozzles; an element which performs a process of varying a liquid pressure inside the pressure chamber in accordance with variation in a potential; and an ejection pulse generating unit which generates an ejection pulse having a determined variation pattern of the potential and generates a first ejection pulse applied to the element upon ejecting first liquid droplets from the nozzles and a second ejection pulse applied to the element upon ejecting second ejection droplets subsequent to the first liquid droplet from the nozzles. The first ejection pulse has a first excitation component exiting the liquid inside the pressure chamber to pressure vibration and a first ejection component generated after generation of the first excitation component and allowing the element to perform a process of ejecting liquid droplets from the nozzles at the time when the pressure of the liquid inside the pressure chamber reaches predetermined pressure. The second ejection pulse has a second excitation component exciting the liquid inside the pressure chamber to pressure vibration and a second ejection component generated after generation of the second excitation component and allowing the element to perform the process of ejecting the liquid droplets from the nozzles at certain time while the pressure of the liquid inside the pressure chamber becomes lower than the predetermined pressure.

According to this liquid ejecting apparatus, it is possible to prevent the liquid pressure inside the pressure chamber from being excessively high, when the process of ejecting the second liquid droplets is performed. Accordingly, even when an ejection frequency is made high by shortening an ejection interval between the first liquid droplet and the second liquid droplet, the second liquid droplet can be ejected stably.

In the liquid ejecting apparatus having the above configuration, the first excitation component may be a component varying a potential from a reference potential to one of the highest potential and the lowest potential. The first ejection component may be a component changing the potential from one of the highest potential and the lowest potential to the other thereof. The second excitation component may be a component varying the potential from the reference potential to one of the highest potential and the lowest potential. The second ejection component may be a component changing potential from one of the highest potential and the lowest potential to the other thereof.

According to this liquid ejecting apparatus, since an operation degree of the element can be maximized, a large pressure variation can be made in the liquid inside the pressure chamber.

In the liquid ejecting apparatus having the above configuration, the variation amount of the potential per unit time in the second excitation component may be smaller than the variation amount of the potential per unit time in the first excitation component.

According to this liquid ejecting apparatus, it is possible to easily restrain the strength of the pressure vibration caused due to the second excitation component.

In the liquid ejecting apparatus having the above configuration, the first ejection pulse may have a first constant potential component connecting an end point of the first excitation component to a start point of the first ejection component with constant potential. In addition, the second ejection pulse may have a second constant potential component connecting an end point of the second excitation component to a start point of the second ejection component with constant potential and a generation period of the second constant potential component is longer than a generation period of the first constant potential component.

According to this liquid ejecting apparatus, by allowing the generation period of the second constant potential component to be longer than the generation period of the first constant potential component, it is possible to easily adjust the liquid pressure inside the pressure chamber at time of performing the process of the element based on the second ejection component.

In the liquid ejecting apparatus having the above configuration, the first ejection pulse may have a first return portion which is generated after the generation of the first ejection component and restrains a pressure variation of the liquid inside the pressure chamber by returning the potential from the other of the highest potential and the lowest potential to the reference potential. The second ejection pulse may have a second return portion which is generated after the generation of the second ejection component and restrain a pressure variation of the liquid inside the pressure chamber by returning the potential to the other of the highest potential and the lowest potential to the reference potential.

According to this liquid ejecting apparatus, thanks to the first and second return portions, it is possible to suppress the pressure vibration inside the pressure chamber after the ejection of the liquid droplets. Accordingly, it is possible to increase an ejection frequency of the liquid droplets.

In the liquid ejecting apparatus having the above configuration, a variation pattern of the potential of the second return portion may be the same as a variation pattern of the potential of the first return portion.

According to this liquid ejecting apparatus, the process of the element for suppressing the pressure vibration is the same by the respective ejection pulses. Accordingly, when a subsequent liquid droplet is ejected after the ejection of a certain liquid droplet, it is possible to suppress a variation of the liquid pressure inside the pressure chamber.

In the liquid ejecting apparatus having the above configuration, the element may be deformed in accordance with a potential determined by the first and second ejection pulses to change a volume of the pressure chamber.

According to this liquid ejecting apparatus, it is possible to efficiently eject the liquid droplets by the first and second ejection pulses.

To realize the following liquid ejecting method is apparent.

According to another aspect of the invention, there is provided the liquid ejecting method including exciting a liquid inside a pressure chamber to pressure vibration by applying a first excitation component to an element which performs a process of varying a liquid pressure inside the pressure chamber in accordance with variation in a potential; allowing the element to perform a process of ejecting liquid droplets from nozzles individually communicating with the pressure chambers by applying a first ejection component to the element after the application of the first excitation component to the element at the time when a pressure of the liquid inside the pressure chamber reaches a predetermined pressure; exciting the liquid inside the pressure chamber to pressure vibration by applying a second excitation component to the element after the liquid droplets are ejected from the nozzles; and allowing the element to perform the process of ejecting the liquid droplets from the nozzles by applying a second ejection component to the element after the application of the second excitation component to the element at certain time while the pressure of the liquid inside the pressure chamber becomes lower than the predetermined pressure.

### First Embodiment

### Overall Configuration of Printer 1

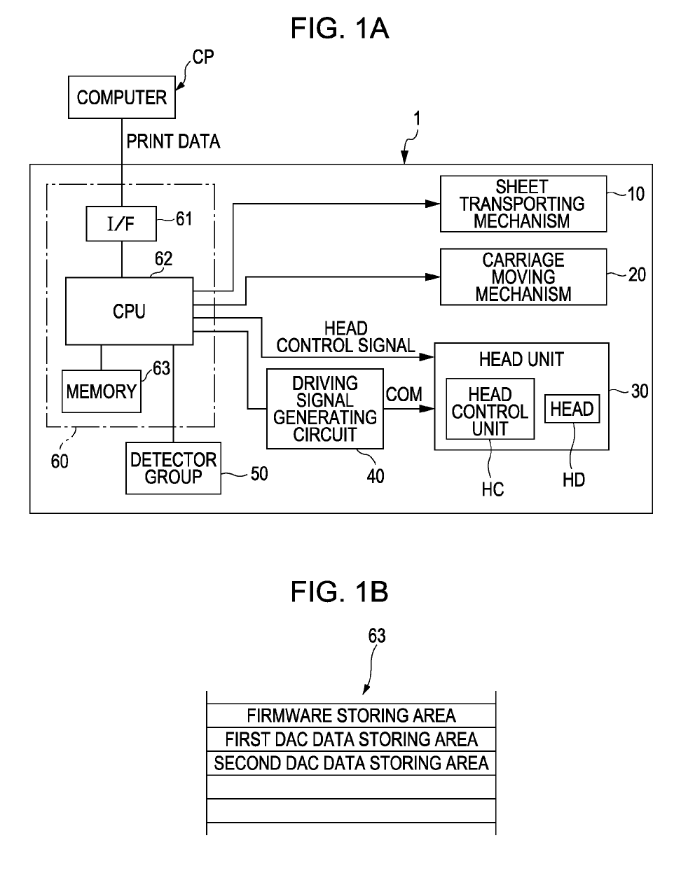

FIG. 1A is a block diagram illustrating the configuration of a printer 1. FIG. 1B is a conceptual diagram illustrating a storage area of a memory 63 included in a printer controller 60. The printer 1 which is an example of a liquid ejecting apparatus prints an image on a medium by ejecting ink as a liquid. Here, ink includes both aqueous ink and oily ink. The medium is a target to which the ejected liquid is landed. An example of the medium is a paper sheet.

As shown in FIG. 1A, the printer 1 includes a sheet transporting mechanism 10, a carriage moving mechanism 20, a head unit 30, a driving signal generating circuit 40, a detector group 50, and the printer controller 60. The sheet transporting mechanism 10 which corresponds to a medium transport unit for transporting the medium transports the paper sheet as the medium. The carriage moving mechanism 20 moves a carriage mounted on the head unit 30 in a carriage movement direction. The carriage movement direction is a direction intersecting a transport direction. For example, the carriage movement direction is a sheet width direction perpendicular to the transport direction. Since the head unit 30 includes a head HD, the carriage movement direction corresponds to a head movement direction.

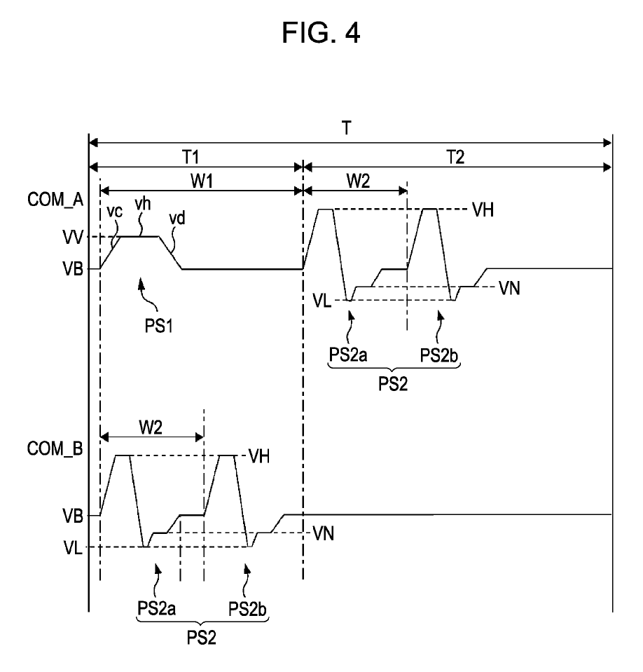

The head unit 30 includes the head HD and a head control unit HC. The head unit 30 is mounted on the carriage. The head HD ejects ink droplets by forming ink as a liquid into the ink droplets. The head control unit HC controls ink ejection of the head HD. The head HD will be described in detail below. The driving signal generating circuit 40 generates a driving signal used at the time of ejecting the ink droplets on the basis of DAC data. The DAC data are data expressing a variation pattern of the potential of the driving signal as time-series data. In the printer 1, a first driving signal COM_A and a second driving signal COM_B (see FIG. 4) are generated. The first driving signal COM A and the second driving signal COM_B each contain an ejection pulse PS2 for ejecting the ink droplets. Accordingly, the driving signal generating circuit 40 corresponds to an ejection pulse generating unit which generates the ejection pulse PS2. The driving signal generating circuit 40 and the generated driving signals COM will be described below.

The detector group 50 includes a plurality of detectors which observe a status of the printer 1. These detectors output a detected result to the printer controller 60. The printer controller 60 controls the operation of the printer 1. That is, the printer controller 60 controls the sheet transporting mechanism 10, the carriage moving mechanism 20, the head HD, the head control unit HC, and the driving signal generating circuit 40 as control targets. The printer controller 60 includes an interface 61, a CPU 62, and the memory 63. The interface 61 transmits and receives data to and from a computer CP as an external apparatus. The CPU 62 is an arithmetic processing device which performs general control in the printer 1. The memory 63 guarantees an area for storing programs for the CPU 62, a work area, or the like. For example, as shown in FIG. 1B, partial areas of the memory 63 are used as a firmware storage area for storing a firmware, a first DAC data storing area for storing the first DAC data for the first driving signal COM_A, and a second DAC data storing area for storing the second DAC data for the second driving signal COM_B.

### Head HD

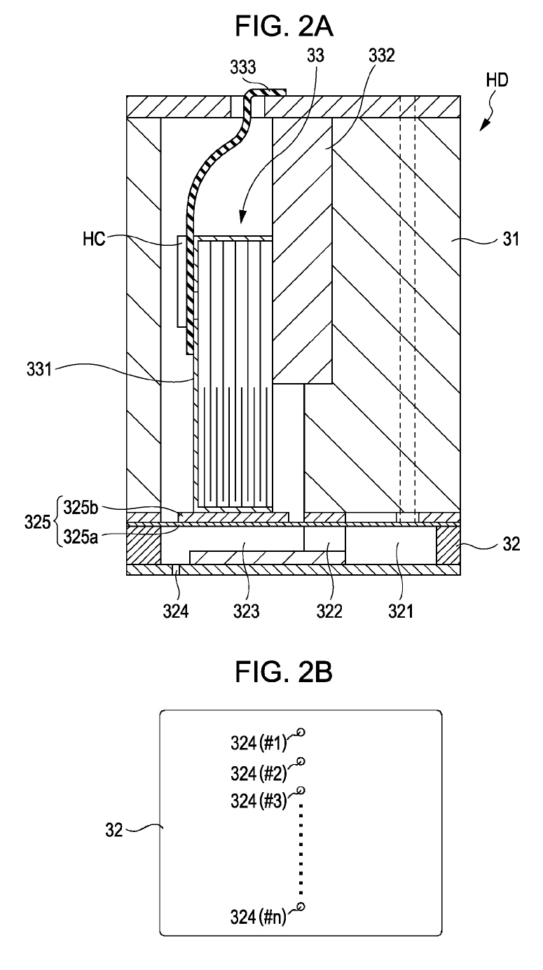

The head HD includes a case 31, a flow passage unit 32, and a piezo element unit 33, for example, as shown in FIG. 2A. The case 31 is formed in a block shape and is a member for accommodating the piezo element unit 33 therein. The flow passage unit 32 is joined to a front end surface of the case 31 facing the paper sheet.

The flow passage unit 32 is a member which has a plurality of ink flow passages formed from a common ink chamber 321 to nozzles 324 through ink supply passages 322 and pressure chambers 323. The ink flow passages are filled with ink at the time of using the printer 1. The nozzles 324 eject ink in a droplet state (corresponding to liquid droplets). For example, as shown in FIG. 2B, a plurality of the nozzles 324 are arranged in the transport direction of the paper sheet to form a nozzle row. In addition, each of the ink flow passages described above is provided for each of the plurality of nozzles 324. That is, the ink supply passage 322 and the pressure chamber 323 are provided for each of the nozzles 324.

The pressure chamber 323 varies an ink pressure at the time of ejecting the ink and communicates with the nozzle 324. The pressure chamber 323 is a space which is slim and long in a direction intersecting an arrangement direction of the nozzles 324. A part of the pressure chamber 323 is partitioned by a diaphragm 325. The diaphragm 325 includes an elastic film 325a and an island portion 325b. The elastic film 325a is a film made of resin and having elasticity and partitions the part of the pressure chamber 323 on a side opposite to the nozzle 324. The island portion 325b is a portion to which a front end surface of a piezo element PZT included in the piezo element unit 33 is joined. The island portion 325b is formed on the surface of the elastic film 325a opposite to the pressure chamber 323. An elastic area of the elastic film 325a is provided in the circumference of the island portion 325b. The island portion 325b of the diaphragm 325 can be moved toward a side of the pressure chamber 323 or toward a side opposite to the pressure chamber 323 by the elasticity of the elastic film 325a. The volume of the pressure chamber 323 becomes smaller when the island portion 325b is moved toward the pressure chamber 323 and the volume of the pressure chamber 323 becomes larger when the island portion 325b is moved toward to the side opposite to the pressure chamber 323. Thanks to variation in the volume of the pressure chamber 323, variation in the ink pressure inside the pressure chamber 323 can be caused. A variation in the volume of the pressure chamber 323 is made by deformation of the piezo element PZT. Accordingly, on the basis of a variation pattern of the potential of the ejection pulse PS2, the ink pressure can be controlled with good precision.

The ink supply passage 322 is a passage which communicate with the common ink chamber 321 and the pressure chamber 323. The shape of the ink supply passage 322 is determined such that supply of ink to the pressure chamber 323 is not excessive or shortage and a pressure variation of the ink inside the pressure chamber 323 is efficiently used for ink ejection. The common ink chamber 321 is a member which temporarily stores the ink supplied from ink cartridges (not shown) or the like to supply the ink to the respective ink flow passages.

In the ink passages, the nozzles 324 and the ink supply passage 322 communicate with the pressure chambers 323. With such a configuration, the phenomenon of the Helmholtz resonator is applied when the features of ink flow or the like is analyzed. That is, when the ink is ejected from the nozzles 324, the pressure variation is made in the ink inside the pressure chambers 323. At this time, the pressure chambers 323, the ink supply passages 322, and the nozzles 324 function as the Helmholtz resonator. Accordingly, when a pressure is applied to the ink inside the pressure chamber 323, the magnitude of the pressure changes at a specific period called a Helmholtz period. In other words, a pressure vibration having a specific vibration period occurs in the ink inside the pressure chamber 323. In the exemplified head HD, the specific vibration period is 6.7 μs. A meniscus (a free surface of ink exposed toward the nozzle 324) is moved with the pressure variation of the ink inside the pressure chamber 323. For example, when the ink pressure increases, the meniscus is moved in an ejection direction inside the nozzle 324. In contrast, when the ink pressure decreases, the meniscus is moved toward the pressure chamber 323 in the nozzle 324.

The piezo element unit 33 includes a piezo element group 331, an adhering board 332, and a head wiring member 333. The piezo element group 331 has a pectinate shape. A portion having one pectinate shape is the piezo element PZT. The piezo element group 331 has the number of piezo elements PZT corresponding to the number of nozzles 324. The piezo element group 331 is adhered to one surface of the adhering board 332 having a rectangular shape and the case 31 is adhered to the other surface of the adhering board 332. Wirings of the piezo elements PZT and the head control unit HC are provided in an element wiring board. The piezo elements PZT are deformed by applying a potential difference between electrodes opposed to each other. In this example, each of the piezo elements PZT is expanded and contracted in a longitudinal direction thereof. An amount of expansion or contraction is determined depending on the potential of the piezo element PZT. The potential of the piezo element PZT is determined as the potential of the applied driving signal COM. That is, the piezo element PZT is charged and discharged to be expanded and contracted by application of the driving signal COM. Since the diaphragm 325 is deformed with the expansion and contraction of the piezo element PZT, the pressure variation of the ink inside the pressure chamber 323 can be made.

This piezo element PZT which is an element charged and discharged by the driving signal COM (the ejection pulse PS2) corresponds to an element for performing a process of ejecting ink (a liquid). In addition, when the piezo element PZT is used for ink ejection, the deformation of the piezo element PZT can be controlled in accordance with the potential of the driving signal COM. Therefore, it is possible to precisely control the process of ejecting the ink.

### Driving Signal Generating Circuit 40

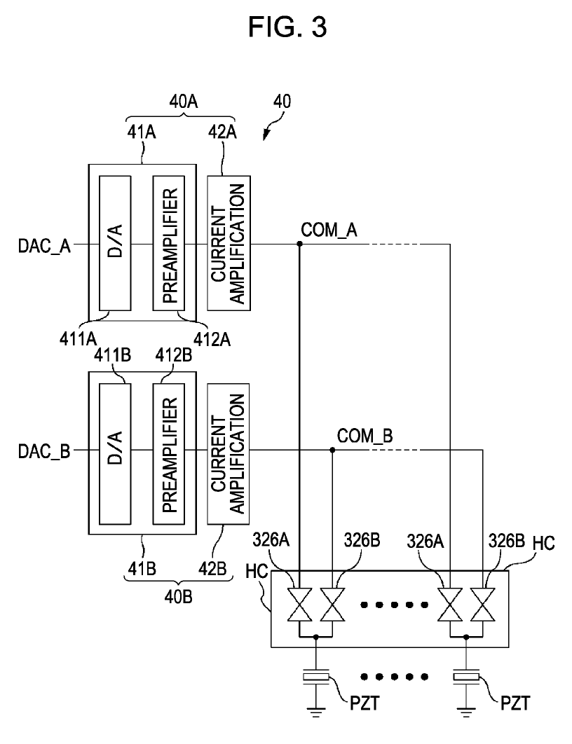

As shown in FIG. 3, the driving signal generating circuit 40 as the ejection pulse generating unit includes a first driving signal generating circuit 40A and a second driving signal generating circuit 40B. The first driving signal generating circuit 40A generates the first driving signal COM_A on the basis of the first DAC data (first potential information). The first driving signal generating circuit 40A includes a first waveform generating circuit 41A and a first current amplifying circuit 42A. The second driving signal generating circuit 40B generates the second driving signal COM_B on the basis of the second DAC data (second potential information). The second driving signal generating circuit 40B includes a second waveform generating circuit 41B and a second current amplifying circuit 42B.

The first waveform generating circuit 41A is a circuit which generates a first waveform signal corresponding to the first DAC data. The first waveform generating circuit 41A includes a first digital analog converter 411A and a first preamplifier 412A. The first digital analog converter 411A is an electric circuit which outputs a potential analog signal according to the first DAC data. Since the first DAC data are stored in the first DAC data storing area of the memory 63, the first DAC data are output from the CPU 62. The first preamplifier 412A amplifies the potential of an analog signal output from the first digital analog converter 411A up to a level suitable for a process of the piezo element PZT and outputs the amplified potential as the first waveform signal. The first current amplifying circuit 42A amplifies the current of the first waveform signal generated by the first waveform generating circuit 41A and outputs the amplified current as the first driving signal COM_A. The first current amplifying circuit 42A includes a set (a pair of transistors) of a PNP transistor and an NPN transistor connected complementarily, for example.

The second waveform generating circuit 41B generates a second waveform signal corresponding to the second DAC data. The second current amplifying circuit 42B amplifies the current of the second waveform signal and outputs the amplified current as the second driving signal COM_B. The configuration of the second waveform generating circuit 41B and the second current amplifying circuit 42B is the same as that of the first waveform generating circuit 41A and the first current amplifying circuit 42A. In brief, the second waveform generating circuit 41B includes a second digital analog converter 411B and a second preamplifier 412B. The second current amplifying circuit 42B includes a set of transistors connected complementarily.

The driving signal generating circuit 40 generates the first driving signal COM A and the second driving signal COM_B by converting the first DAC data expressing the potential of the first driving signal COM_A in the time series and the second DAC data expressing the potential of the second driving signal COM_B in the time series into analog data, respectively. Accordingly, the variation pattern of the potential of the driving signals COM_A and COM_B can be set minutely on the basis of the respective DAC data. In consequence, an amount of ink droplet ejected or a flying speed of the ejected ink droplet can be determined with good precision.

The first driving signal COM_A generated by the first driving signal generating circuit 40A and the second driving signal COM B generated by the second driving signal generating circuit 40B are selectively applied to the respective piezo elements PZT. Accordingly, the head control unit HC is provided with each of sets of a first switch 326A and a second switch 326B is provided in each of the piezo elements PZT. The first switch 326A is provided in a signal line supplying the first driving signal COM A to apply the first driving signal COM_A to the piezo element PZT or block the first driving signal COM_A. The second switch 326B is provided in a signal line supplying the second driving signal COM_B to apply the second driving signal COM_B to the piezo element PZT or block the second driving signal COM_B. The head control unit HC controls the first switch 326A and the second switch 326B on the basis of a head control signal from the printer controller 60 to apply necessary portions of the first driving signal COM A and the second driving signal COM_B to the piezo elements PZT.

### Overview of Driving Signal COM

Next, the driving signal COM will be described. The overview of the driving signal COM will be first described. The driving signal COM in the printer 1 contains the ejection pulse PS2 which is applied to the piezo element PZT when the ink droplets are ejected and a minute vibration pulse PS1 which is applied to the piezo element PZT in order to restrain the ink from being thickened when the ink droplets are not ejected. The ejection pulse PS2 and the minute vibration pulse PS1 each have the variation pattern of the potential based on the process performed on the piezo element PZT and correspond to a driving pulse for driving the piezo element PZT.

In the printer 1, the ejection pulse PS2 corresponding to a target ejection amount (11 ng) of the ink droplets is continuously applied to the piezo elements PZT, when a large dot is formed. The variation pattern of the potential of the ejection pulse PS2 (a first ejection pulse PS2a) applied to odd-numbered piezo elements PZT is different from the variation pattern of the potential of the ejection pulse PS2 (a second ejection pulse PS2b) applied to even-numbered piezo elements PZT. Even though described in detail below, the first ejection pulse PS2a applied to odd-numbered piezo elements PZT permits the ink droplets from the nozzles 324 to be ejected by rapidly contracting the pressure chambers 323 at the time when the ink pressure inside the pressure chambers 323 reaches a predetermined pressure. On the other hand, the second ejection pulse PS2b applied to even-numbered piezo elements PZT permits the ink droplets from the nozzles 324 to be ejected by rapidly contracting the pressure chambers 323 at a certain time while the ink pressure inside the pressure chambers 323 is lower than the predetermined pressure.

With such a configuration, even when an interval between the first ejection pulse PS2a applied to odd-numbered piezo elements PZT and the second ejection pulse PS2b applied to even-numbered piezo elements PZT is made shorter, the ink droplets ejected by the second ejection pulse PS2b to even-numbered piezo elements PZT can be ejected stably. In consequence, the ejection frequency of the ink droplets can be higher.

### Details of Driving Signal COM

As shown in FIG. 4, the first driving signal COM A is repeatedly generated in every repetition period T and contains a first first-half portion generated in a first-half period T1 and a first second-half portion generated in a second-half period T2. The minute vibration pulse PS1 is contained in the first first-half portion and the ejection pulse PS2 is contained in the first second-half portion. The second driving signal COM_B is also repeatedly generated in every repetition period T and contains a second first-half portion generated in the first-half period T1 and a second second-half portion generated in the second-half period T2. The ejection pulse PS2 is contained in the second first-half portion and a middle potential VB as the reference potential is constant in the second second-half portion.

The minute vibration pulse PS1 is a pulse which is applied to the piezo element PZT when the ink droplets are not ejected. The exemplified minute vibration pulse PS1 is formed by a trapezoid wave. That is, the minute vibration pulse PS1 includes a minute vibration expansion component vc, a minute vibration hold component vh, and a minute vibration contraction component vd. The minute vibration expansion component vc is a component increasing a potential at a constant gradient (a potential variation amount per unit time) from the middle potential VB to a minute vibration potential VV. The piezo element PZT is contracted when the minute vibration expansion component vc is applied to the piezo element PZT. Then, the volume of the pressure chamber 323 is expanded from a reference volume corresponding to the middle potential VB to a minute vibration volume corresponding to the minute vibration potential VV. The minute vibration hold component vh is a constant component in the minute vibration potential VV. When the minute vibration hold component vh is applied to the piezo element PZT, the piezo element PZT maintains a contracted state corresponding to the minute vibration potential VV and the pressure chamber 323 maintains the minute vibration volume. The minute vibration contraction component vd is a component for decreasing the potential at a constant gradient from the minute vibration potential VV to the middle potential VB. When the minute vibration contraction component vd is applied to the piezo element PZT, the piezo element PZT is expanded. The volume of the pressure chamber 323 is contracted up to the reference volume.

A weak pressure variation by which the ink droplets are not ejected occurs in the ink inside the pressure chamber 323 with the variation in the volume of the pressure chamber 323. Due to the weak pressure variation, the meniscus is moved in a direction opposite to a direction in which the meniscus is drawn toward the pressure chamber 323. In consequence, the ink present in the vicinity of the nozzle 324 is mixed, thereby restraining the ink from becoming thickened.

The ejection pulse PS2 is a pulse which is applied to the piezo element PZT when the ink droplets are ejected. The ejection pulse PS2 is constituted by one pair of pulses having the same target ejection amount of the ink droplet. That is, the ejection pulse PS2 is constituted by a first ejection pulse PS2a and a second ejection pulse PS2b. The first ejection pulse PS2a is a pulse which is first generated in the first second-half portion and the second first-half portion. The second ejection pulse PS2b is a pulse which is generated in the first second-half portion and the second first-half portion after the first ejection pulse PS2a is generated. In the first driving signal COM_A and the second driving signal COM_B exemplified, the first ejection pulse PS2a in the first second-half portion starts to be generated after the minute vibration ejection pulse PS2 starts to be generated and a predetermined period W1 elapses. In this example, the first ejection pulse PS2a starts to be generated after 35.5 μs elapses. In addition, the first ejection pulse PS2a in the second first-half portion starts to be generated at the same time as generation start time of the minute vibration ejection pulse PS2. The second ejection pulse PS2b starts to be generated after the first ejection pulse PS2a starts to be generated and a predetermined period W2 elapses. In this example, either the second ejection pulse PS2b in the first second-half portion or the second ejection pulse PS2b in the second first-half portion starts to be generated after 17.6 μs elapses from the start of the generation of the first ejection pulse PS2a having been generated first.

At the time of forming a large dot, the first second-half portion is applied to the piezo element PZT after the second first-half portion is applied to the piezo element PZT. In other words, all the ejection pulses PS2 are applied to the piezo element PZT. In this case, the first ejection pulse PS2a in the second first-half portion is first applied to the piezo element PZT and then the second ejection pulse PS2b in the second first-half portion is subsequently applied to the piezo element PZT. Subsequently, the first ejection pulse PS2a in the first second-half portion is applied and then the second ejection pulse PS2b in the first second-half portion is finally applied. In short, the first ejection pulse PS2a and the second ejection pulse PS2b are alternately applied to the piezo element PZT.

### Ejection Pulse PS2

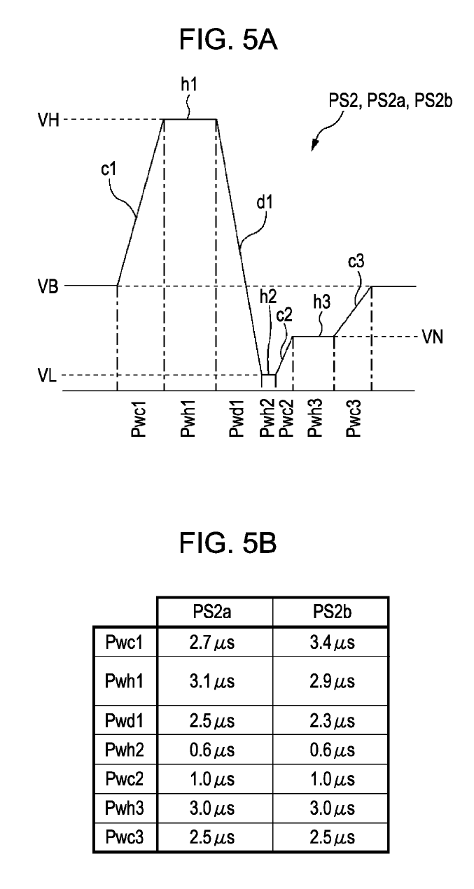

Next, the ejection pulse PS2 will be described. First, the components included in the ejection pulse PS2 will be described. The components are the same as those in the first ejection pulse PS2a and the second ejection pulse PS2b. As shown in FIG. 5A, the ejection pulse PS2 includes a first expansion component c1, a first hold component h1, a contraction component d1, a second hold component h2, a second expansion component c2, a third hold component h3, and a third expansion component c3.

The first expansion component c1 is a component increasing a potential at a constant gradient from the middle potential VB to the highest potential VH. When the first expansion component c1 is applied, the piezo element PZT is contracted. At this time, the pressure chamber 323 is expanded from the reference volume corresponding to the middle potential VB to the maximum volume corresponding to the highest potential VH. Then, ink is supplied by the expansion of the pressure chamber 323 from the ink supply passage 322 to the pressure chamber 323, and much amount of ink droplets can be ejected by the contraction component d1. Simultaneously, pressure vibration (forced vibration) is excited in the ink inside the pressure chamber 323. The first expansion component c1 corresponds to an excitation component.

The first hold component h1 is a component holding the highest potential VH for predetermined time. The first hold component h1 corresponds to a constant potential component connecting the end point of the first expansion component c1 to the start point of the contraction component d1 at a constant potential. When the first hold component hi is applied, the piezo element PZT holds a contracted state. At this time, the pressure chamber 323 keeps the maximum volume. During an application period of the first hold component h1, the ink pressure inside the pressure chamber 323 is varied by residual vibration.

The contraction component d1 is a component decreasing a potential at a constant gradient from the highest potential VH to the lowest potential VL. When the contraction component d1 is applied, the piezo element PZT is expanded. At this time, the pressure chamber 323 is rapidly contracted from the maximum volume to the minimum volume. In consequence, when the ink pressure inside the pressure chamber 323 increases, the ink droplets are ejected from the nozzles 324. With such a configuration, the contraction component d1 corresponds to an ejection component ejecting the ink droplets. In the ejection pulse PS2, a deformation amount of the element can be maximized, since the contraction component d1 drops the potential from the highest potential VH to the lowest potential VL. In this way, a large pressure variation of the ink inside the pressure chamber 323 can be caused. A difference between the highest potential VH and the lowest potential VL is 31 V (25° C.)

The second hold component h2 is a component holding the lowest potential VL for very short time and ensures control time necessary to transfer control by the second expansion component c2. The second hold component h2 forms a part of a return portion. The second hold component c2 is a component increasing a potential at a constant gradient from the lowest potential VL to a vibration suppression potential VN. By applying the second expansion component c2, the piezo element PZT is expanded from the minimum volume to a vibration suppression volume corresponding to the vibration suppression potential VN. Here, the vibration suppression potential VN is determined between the lowest potential VL and the middle potential VB. The vibration suppression potential VN regulates an expansion degree of the pressure chamber 323 by the third expansion component c3 (a vibration suppression component) as described below. Accordingly, the second expansion component c2 corresponds to a volume adjustment component adjusting the volume of the pressure chamber 323. In addition, the second hold component h2 also forms a part of the return portion. The third hold component h3 is a component holding the vibration suppression potential VN for predetermined time and determines the time of starting the expansion of the pressure chamber 323 by the third expansion component c3. Accordingly, the third hold component h3 corresponds to a time adjustment component adjusting vibration suppression time. In addition, the third hold component h3 also forms a part of the return portion.

The third expansion component c3 is a component increasing a potential at a constant gradient from the vibration suppression potential VN to the middle potential VB. When the third expansion component c3 is applied, the piezo element PZT is contracted. Then, the pressure chamber 323 is expanded from the vibration suppression volume to the reference volume. Accordingly, since the pressure variation of the ink inside the pressure chamber 323 after ejection of the ink droplets is lessened, subsequent ejection of the ink droplets can be early started. That is, it is possible to increase the ejection frequency of the ink droplets. The third expansion component c3 corresponds to the vibration suppression component. Here, the expansion degree of the pressure chamber 323 by the third expansion component c3 is adjusted by the second expansion component c2 and the time of starting the expansion of the pressure chamber 323 is determined by the third hold component h3. Since the expansion of the pressure chamber 323 by the third expansion component c3 is optimized by the second expansion component c2 and the third hold component h3, the pressure variation of the ink can be effectively restrained. In addition, the third expansion component c3 also forms a part of the return portion.

### Ejection Pulses PS2a and PS2b

As described above, the first ejection pulse PS2a and the second ejection pulse PS2b have the same target ejection amount, but have the different variation patterns of the potential. That is, the ink pressure inside the pressure chamber 323 is determined so as to be lower in the time when the pressure chamber 323 is contracted to eject the ink droplets by the second ejection pulse PS2b than in the time when the pressure chamber 323 is contracted to eject the ink droplet by the first ejection pulse PS2a.

Specifically, generation periods of the components from the first expansion component c1 to the third expansion component c3 are determined as periods shown in FIG. 5B. In the first ejection pulse PS2a, the generation period of the first expansion component c1 as a first excitation component is determined as 2.7 μs, the generation period of the first hold component h1 as a first constant potential component is determined as 3.1 μs, and the generation period of the contraction component d1 as a first ejection component is determined as 2.5 μs. The generation periods of the second hold component h2, the second expansion component c2, the third hold component h3, and the third expansion component c3 functioning as a first return portion are as follows. That is, the generation period of the second hold component h2 is 0.6 μs, the generation period of the second expansion component c2 is 1.0 μs, the generation period of the third hold component h3 is 3.0 μs, and the generation period of the third expansion component c3 is 2.5 μs.

On the other hand, in the second ejection pulse PS2b, the generation period of the first expansion component c1 as a second excitation component is determined as 3.4 μs, the generation period of the first hold component h1 as a second constant potential component is determined as 2.9 μs, and the generation period of the contraction component d1 as a second ejection component is determined as 2.3 μs. The generation periods of the second hold component h2, the second expansion component c2, the third hold component h3, and the third expansion component c3 functioning as a second return portion are the same as those of the first ejection pulse PS2a. That is, the generation period of the second hold component h2 is 0.6 μs, the generation period of the second expansion component c2 is 1.0 μs, the generation period of the third hold component h3 is 3.0 μs, and the generation period of the third expansion component c3 is 2.5 μs.

The first ejection pulse PS2a and the second ejection pulse PS2b will be compared to each other. Whereas the generation period of the first expansion component c1 (the first excitation component) of the first ejection pulse PS2a is 2.7 μs, the generation period of the first expansion component c1 (the second excitation component) of the second ejection pulse PS2b is 3.4 μs. As known in the waveform of FIG. 5A, a potential difference in the first expansion component c1 is the same as that in the first ejection pulse PS2a and the second ejection pulse PS2b. Therefore, the expansion speed (an expansion amount per unit time) of the pressure chamber 323 becomes smaller in a case of using the second ejection pulse PS2b than in a case of using the first ejection pulse PS2a. Therefore, the amplitude of the pressure vibration excited in the ink inside the pressure chamber 323 is smaller in a case of using the first expansion component c1 of the second ejection pulse PS2b than in a case of using the first expansion component c1 of the second ejection pulse PS2b.

The ink pressure inside the pressure chamber 323 varies during the application period of the first hold component h1. At this time, the ink pressure inside the pressure chamber 323 varies periodically. In addition, a variation aspect is determined depending on factors such as an expansion degree or an expansion speed (an excitation degree) of the pressure chamber 323 by the first expansion component c1 or a specific vibration period of the ink inside the pressure chamber 323. In addition, the ink pressure at an application start time of the contraction component d1 can be adjusted during the generation period of the first hold component h1.

Accordingly, by varying one or both of the length of the generation period of the first expansion component c1 and the length of the generation period of the first hold component h1, it is possible to adjust the ink pressure at the application start time of the contraction component d1.

In this embodiment, the generation period of the first hold component h1 is determined such that the ink pressure at the application start time of the contraction component d1 of the second ejection pulse PS2b is lower than the ink pressure (corresponding to a predetermined pressure) at the application start time of the contraction component d1 of the first ejection pulse PS2a. Specifically, whereas the generation period of the first hold component h1 (the first constant potential component) included in the first ejection pulse PS2a is determined as 3.1 μs, the generation period of the first hold component h1 (the second constant potential component) included in the second ejection pulse PS2b is determined as 2.9 μs.

When the ink inside the pressure chamber 323 is rapidly pressurized with application of the contract component d1, the ink is ejected as the ink droplets from the nozzles 324. Here, the generation period of the contraction component d1 (the first ejection component) of the first ejection pulse PS2a is 2.5 μs. On the other hand, the generation period of the contraction component d1 (the second ejection component) of the second ejection pulse PS2b is 2.3 μs. A potential difference is the same in the first contraction component d1 and the second contraction component d1. Accordingly, a contraction speed of the pressure chamber 323 by the contraction component d1 of the second ejection pulse PS2b is higher than a contraction speed of the pressure chamber 323 by the first ejection pulse PS2a. A cause that a difference is made between the above contraction speeds is as follows. That is, the ink pressure inside the pressure chamber 323 at the application start time of the contraction component d1 is lower in the case of using the second ejection pulse than in the case of using the first ejection pulse PS2a. The ink pressure at this time has an influence on the flying speed of the ink droplet. That is, the higher the ink pressure is, the higher the flying speed becomes. Therefore, when the gradient of the contraction component d1 of the second ejection pulse PS2b is made equal to the gradient of the contraction component d1 of the first ejection pulse PS2a, the flying speed of the ink droplet ejected by the second ejection pulse PS2b may become excessively low. Taking this circumstance into consideration, the printer 1 is configured such that the flying speed of the ink droplet does not become excessively low by allowing the generation period of the contraction component d1 of the second ejection pulse PS2b to be shorter than the generation period of the contraction component d1 of the first ejection pulse PS2a.

The generation periods of the second hold component h2, the second expansion component c2, the third hold component h3, and the third expansion component c3 functioning as the first and the second return portions are the same in the first ejection pulse PS2a and the second ejection pulse PS2b. The fact that the generation periods thereof are the same is because of the following idea. As described above, the target ejection amount of the ink droplets in the first ejection pulse PS2a is the same as that in the second ejection pulse PS2b. The flying speed of the ink droplets is set such that a big difference is not made by adjusting the gradient of the contraction component d1. For this reason, it is considered that the pressure variation of the ink inside the pressure chamber 323 is not considerably made in the case of using the first ejection pulse PS2a and in the case of using the second ejection pulse PS2b. Accordingly, by allowing the variation patterns of the potential to be the same one another in the respective components functioning as the first and second return portions, it is possible to solve the pressure variation of the ink early after the ejection of the ink droplets by allowing the variation patterns of the potentials of the first ejection pulse PS2a and the second ejection pulse PS2b to be the same one another. Accordingly, it is possible to increase the ejection frequency of the ink droplets.

### Evaluation Result

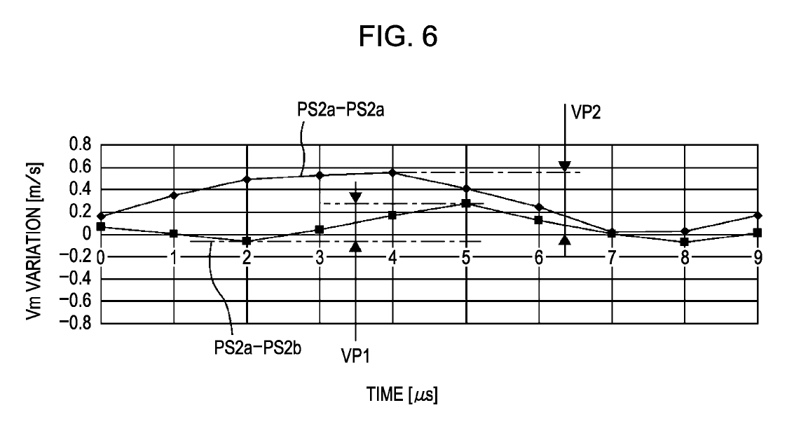

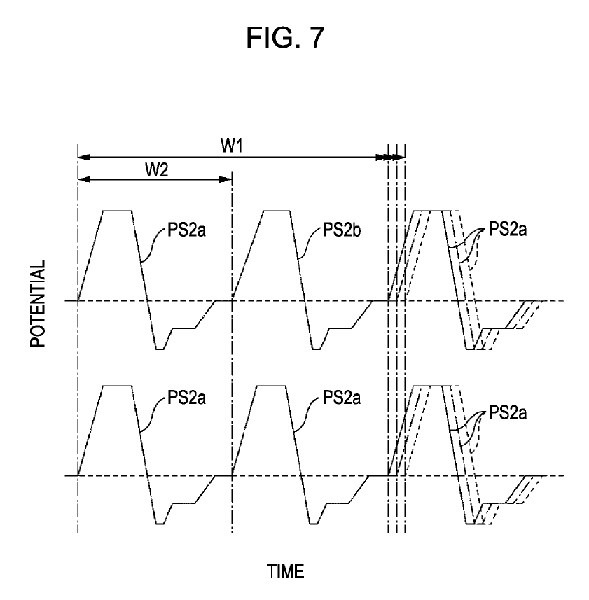

Next, an evaluation result obtained by making the variation pattern of the potential different between the first ejection pulse PS2a and the second ejection PS2b will be described. FIGS. 6 and 7 are explanatory diagrams illustrating the evaluation result.

FIG. 6 is a diagram illustrating a variation amount of the ink droplets from a normal flying speed. Specifically, FIG. 6 shows a variation of the flying speed in a third ejection pulse PS2 when three ejection pulses PS2 are continuously applied to the piezo element PZT and an interval between a second ejection pulse PS2 and the third ejection pulse PS2 is varied. The vertical axis of FIG. 6 represents the variation of the flying speed of the ink droplets. The horizontal axis of FIG. 6 represents a difference between intervals in the driving signal COM which are associated with the interval from the second ejection pulse PS2 to the third ejection pulse PS2. In FIG. 6, a segment indicated by a square line shows an evaluation result of this embodiment. Specifically, this segment shows the evaluation result when the second ejection pulse PS2b subsequent to the first ejection pulse PS2a is applied to the piezo elements PZT. On the other hand, a segment indicated by a lozenge line shows an evaluation result of a comparative example. Specifically, this segment shows the evaluation result when the first ejection pulse PS2a is continuously applied to the piezo element PZT.

FIG. 7 is an explanatory diagram illustrating an ejection pulse group used for evaluation. The upper part of FIG. 7 explains the ejection pulse group for evaluating this embodiment. The lower part of FIG. 7 explains the ejection pulse group for evaluating a reference example. In FIG. 7, the vertical axis represents a potential and the horizontal axis represents time. In addition, in either the ejection pulse group of this embodiment or the ejection pulse group of the comparative example, an application start time of the second ejection pulse PS2 is determined by the same interval (the predetermined period W2) as that of the driving signal COM. In FIG. 7, the third ejection pulse PS2 applied to the piezo element PZT is shown as three kinds of lines, that is, a solid line, one-dot chain line, and a dotted line. This means that the flying speed of the ink droplets is repeatedly measured by delaying the generation time of the ejection pulse PS2. The application start time (the predetermined period W1) of the first ejection pulse PS2a in the first second-half portion of the driving signal COM is a reference time of the application start time of the third ejection pulse PS2. In addition, the measurement is carried out by making the generation time longer from the reference time in every predetermined interval.

In this embodiment, as shown in FIG. 6, the flying speed of the ink droplet varies periodically. It is considered that this variation occurs due to the pressure vibration of the ink inside the pressure chamber 323 after the ejection of a second ink droplet. After the ejection of the ink droplets, residual vibration occurs in the ink inside the pressure chamber 323. In order to suppress the residual vibration, the return portion is applied to the piezo element PZT. However, even when the return portion is applied, the pressure vibration of the ink may remain. In addition, it is considered that the flying speed of the ink droplets by the third ejection pulse PS2 varies in accordance with the ink pressure at the application start time of the ejection pulse PS2. That is, it is considered that the flying speed of the ink droplets becomes higher as the ink pressure at the application start time is higher. In addition, it is considered that the flying speed of the ink droplets becomes lower as the ink pressure is lower. Accordingly, the flying speed of the ink droplets by the third ejection pulse PS2 considerably varies, as the amplitude of the residual vibration in the ink pressure after the application of the return portion is larger.

When a variation range of the flying speed in the ejection pulse group of this embodiment is compared to that in the ejection pulse group of the comparative example, it can be known that the variation range of the ejection pulse group according to this embodiment is smaller. For example, when the ejection pulse group according to this embodiment is used, the maximum variation range is a range indicated by VP1 shown in FIG. 6. In contrast, when the ejection pulse group according to the comparative example is used, the maximum variation range is a range indicated by VP2 shown in FIG. 6. In addition, the variation range VP2 is about 1.5 times of the variation range VP1. In this way, by using the ejection pulse group of this embodiment, it is possible to suppress the pressure vibration after the application of the second ejection pulse PS2b. Accordingly, it can be said that the ejection of the ink droplets can be realized at a high frequency.

Moreover, by determining the ink pressure at the application start time of the contraction component d1 (the second ejection component) included in the second ejection pulse PS2b so as to be lower than the ink pressure at the application start time of the contraction component d1 (the first ejection component) included in the first ejection pulse PS2a, it is possible to allow the residual vibration of the ink pressure after the application of the second ejection pulse PS2b to be smaller. Accordingly, it is possible to increase the ejection frequency of the ink droplets.

Here, in the ejection pulse group according to this embodiment, by allowing the generation period of the first expansion component c1 in the second ejection pulse PS2b to be longer than the generation period of the first expansion component c1 in the first ejection pulse PS2a, the ink pressure inside the pressure chamber 323 at the application start time of the contraction component d1 is made low. In other words, by allowing the gradient (a variation amount of the potential per unit time) of the second excitation component to be smaller than the gradient of the first excitation component, a liquid pressure at the application start time of the second ejection component is made lower than a liquid pressure (predetermined pressure) at the application start time of the first ejection component.

At this time, when the first expansion component c1 is applied to the piezo element PZT, the pressure vibration is excited in the ink inside the pressure chamber 323. In this case, the ink pressure in the pressure chamber 323 varies, as time elapses. For this reason, the ink pressure inside the pressure chamber 323 at the application start time of the contraction component d1 also varies in accordance with the generation period of the first hold component h1. Accordingly, even when the generation period of the first hold component h1 is adjusted, the same advantage can be obtained. In short, by adjusting at least one of the generation period of the contraction component d1 and the generation period of the first hold component h1, it is possible to allow the liquid pressure at the application start time of the second ejection component to be lower than the liquid pressure at the application start time of the first ejection component.

### Evaluation of Ejection Pulse PS2

In the driving signal COM according to this embodiment, the variation pattern of the potential of the first ejection pulse PS2a is different from the variation pattern of the potential of the second ejection pulse PS2b. Here, a known evaluation apparatus ejects ink droplets using one kind of ejection pulse. For this reason, an appropriate evaluation could not be carried out, when the ink droplets are ejected at a high frequency by use of plural kinds of ejection pulses PS2a and PS2b having different variation patterns of the potentials like the driving signal COM of this embodiment. In view of this circumstance, the three ejection pulses PS2 are used for the evaluation in this embodiment, as shown in FIG. 7.

That is, the ink droplets are continuously ejected by the first ejection pulse PS2a (a previous ejection pulse) applied to the piezo element PZT first time, the second ejection pulse PS2b (an evaluation target ejection pulse) as an evaluation target applied to the piezo element PZT second time, and the first ejection pulse PS2a (a subsequent ejection pulse) applied to the piezo element PZT third time to measure the flying speed of the ink droplet. The flying speed of the ink droplet is measured several times by allowing an interval between the second ejection pulse PS2b applied second time and the first ejection pulse PS2a applied third time to be different from each other. Then, the variation pattern of the potential is evaluated in the second ejection pulse PS2b, on the basis of a relation between the interval between the second ejection pulse PS2b and the first ejection pulse PS2a and the flying speed of the ink droplet, for example, on the basis of the range of the variation of the flying speed.

Taking this evaluation method, the pressure variation of the ink inside the pressure chamber 323 after the ejection of the ink droplets by the second ejection pulse PS2b can be recognized on the basis of the relation between the interval between the second ejection pulse PS2b and the first ejection pulse PS2a and the flying speed of the ink droplet. Accordingly, even when the ejection frequency is made higher, it is possible to appropriately evaluate the second ejection pulse PS2b. Hereinafter, detailed description will be made.

### Ejection Pulse Evaluation Apparatus 100

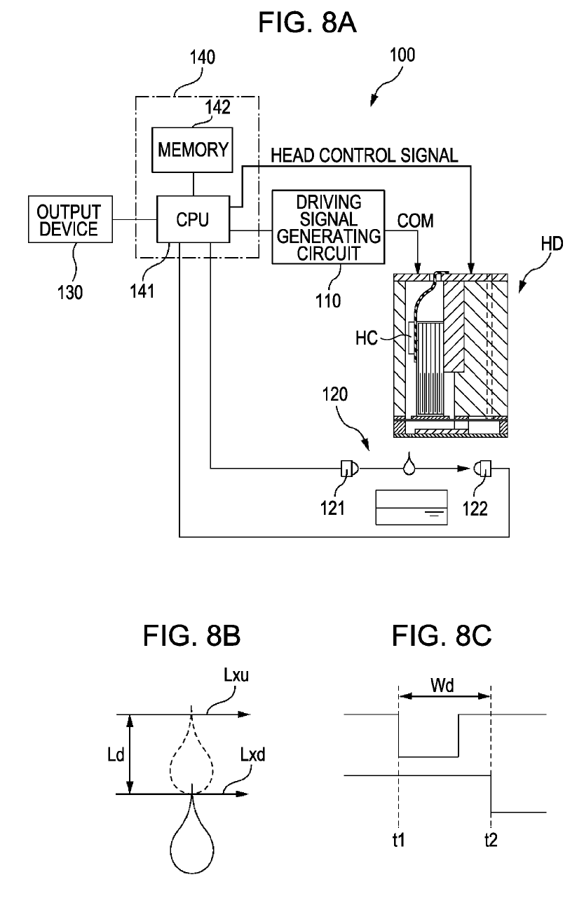

FIG. 8A is an explanatory diagram illustrating an ejection pulse evaluating apparatus 100. The evaluating apparatus 100 includes a head HD, a head control unit HC, a driving signal generating circuit 110, an ink droplet detecting unit 120, an output device 130, and a controller 140. In this configuration, the head HD, the head control unit HC, and the driving signal generating circuit 110 are the same as those of the printer 1. That is, as described in FIG. 2A, the head HD includes pressure chambers 323 communicating with nozzles 324 and ink supply passages 322 and piezo elements PZT causing a pressure variation to ink inside the pressure chambers 323 by changing the volume of the pressure chambers 323. The driving signal generating circuit 110 functioning as an ejection pulse generating unit generates a driving signal COM containing an ejection pulse PS2. Detailed description of these units will be omitted.

The ink droplet detecting unit 120 is a unit which detects ink droplets ejected from the head HD. The ink droplet detecting unit 120 includes a light-emitting unit 121 and a light-receiving unit 122. The light-emitting unit 121 includes a semiconductor laser and the light-receiving unit 122 includes a photo diode. The light-emitting unit 121 outputs a laser beam toward the light-receiving unit 122. The light-receiving unit 122 outputs a signal having an H level during a period of receiving the laser beam from the light-emitting unit 121. As shown in FIG. 8B, the ink droplet is ejected in a path for blocking the laser beam. Accordingly, as shown in FIG. 8C, a signal having an L level is output from the light-receiving unit 122, while the laser beam by the ink droplet is blocked. The exemplified ink droplet detecting unit 120 is provided with two sets of the light-emitting unit 121 and the light-receiving unit 122 in a vertical direction. With such a configuration, the flying speed of the ink droplet can be measured by a distance between the laser beams and blocked time. In the example shown in FIGS. 8B and 8C, a distance between an upper laser beam LXu and a lower laser beam LXd is denoted by Ld and a period from time t1 of measuring the ink droplet in the upper light-receiving unit 122 and time of measuring the ink droplet in the lower light-receiving unit 122 is denoted by Wd. Accordingly, the flying speed of the ink droplet is equal to Ld/Wd. In addition, the configuration of the ink droplet detecting unit 120 is not limited to the above configuration, as long as the ink droplet can be detected.

The controller 140 controls an operation of the evaluating apparatus 100 and includes a CPU 141 and a memory 142. The CPU 141 controls the head HD and the driving signal generating circuit 110 on the basis of a firmware or DAC data stored in the memory 142. In addition, the flying speed of the ink droplet is calculated on the basis of a signal output from the light-receiving unit 122. Accordingly, the controller 140 functions as a speed measuring unit which measures the flying speed of the ink droplet together with the ink droplet detecting unit 120. The output device 130 outputs a variety of information associated with the measurement. For example, the output device 130 outputs a measurement condition, a potential difference and a generation period of each component in the ejection pulse PS2, and the flying speed of the ink droplet. The output device 130 may be a device which outputs information on a sheet or may display information on a display. In short, any output device may be used, as long as the output device can output information.

### Evaluation Result

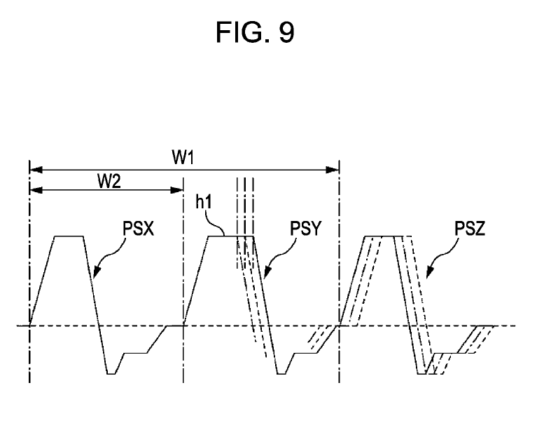

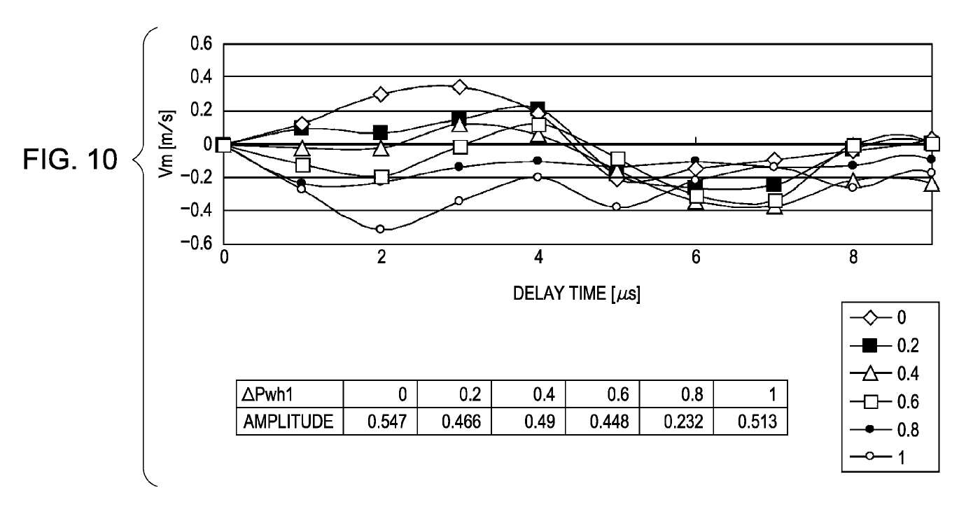

Next, an evaluation result obtained at the time of varying the generation period of the first hold component hi will be described with reference to FIGS. 9 to 12. FIG. 9 is an explanatory diagram illustrating the ejection pulse group used for evaluation. FIG. 10 is a diagram illustrating a relation between the variation of the flying speed of the ink droplet and the interval from the second ejection pulse (an evaluation target ejection pulse PSY) to the third ejection pulse (a subsequent ejection pulse PSZ) in every kind of second ejection pulse.

First, the ejection pulse group used for evaluation will be described. As shown in FIG. 9, the ejection pulse group is constituted by three ejection pulses. A first ejection pulse PS2 is the previous ejection pulse PSX, a second ejection pulse PS2 is the evaluation target ejection pulse PSY, and a third ejection pulse PS2 is the subsequent ejection pulse PSZ. That is, one ejection pulse PSX and one ejection pulse PSZ before and after the evaluation target ejection pulse PSY as an evaluation target are generated and applied to the piezo element PZT.

The previous ejection pulse PSX, the evaluation target ejection pulse PSY, and the subsequent ejection pulse PSZ each have the components shown in FIG. 5A. Accordingly, a first expansion component c1 included in the previous ejection pulse PSX corresponds to the first excitation component exciting the ink inside the pressure chamber 323 to pressure vibration. In addition, a contraction component d1 corresponds to the first ejection component allowing the piezo element PZT to perform the process of ejecting the ink droplets from the nozzles 324. Likewise, a first expansion component c1 included in the evaluation target ejection pulse PSY corresponds to the second excitation component. In addition, the contraction component d1 corresponds to the second ejection component. Likewise, a first expansion component c1 included in the subsequent ejection pulse PSZ corresponds to the third excitation component. In addition, the contraction component d1 corresponds to the third ejection component.

The previous ejection pulse PSX and the subsequent ejection pulse PSZ are determined so as to have the same variation pattern of the potential as the variation pattern of the potential of the first ejection pulse SP2a. Since the variation pattern of the potential and the generation period in the respective components have been described (see FIGS. 5A and 5B), the description will be omitted. On the other hand, the evaluation target ejection pulse PSY has a variation pattern of the potential determined by use of the above-described first ejection pulse PS2a as a reference. In this example, as schematically illustrated in FIG. 9, a plurality of the evaluation target ejection pulses PSY obtained by making the generation period of the first hold component h1 longer gradually are evaluation targets. Specifically, as shown in the lower part of FIG. 10, the total six evaluation target ejection pulses PSY having the same variation pattern of the potential as the variation pattern of the potential of the first ejection pulse PS2a, that is, from the evaluation target ejection pulse (ΔPwh1=0 μs), in which the generation period of the first hold component h1 is the same as that of the first hold component hi of the first ejection pulse PS2a, to the evaluation target ejection pulse (ΔPwh1=1 μs), in which the generation period of the first hold component h1 is longer than that of the first hold component h1 of the first ejection pulse PS2a by 1 μs, are the evaluation targets.

The flying speed of the ink droplet ejected by the subsequent ejection pulse PSZ is measured in each of the evaluation target ejection pulses PSY. At this time, the flying speed of the ink droplet is measured several times by allowing the interval between the evaluation target ejection pulse PSY and the subsequent ejection pulse PSZ to be longer gradually. Specifically, a case where the interval between the subsequent ejection pulse PSZ and the previous ejection pulse PSZ is equal to that of the driving signal COM, that is, the case of the predetermined interval W1, is set as a reference (delay time=0 μs). The flying speed is measured by delaying the generation start time of the subsequent ejection pulse PSZ by 1 μs up to 9 μs.

FIG. 10 shows the evaluation result. Here, the variation (a difference between the maximum value and the minimum value) of the flying speed is used for this evaluation. As described in FIG. 6, the variation of the flying speed means the variation in the ink pressure at the application start time of the contraction component d1. Therefore, it can be said that the ejection of the ink droplets is stable as the variation of the flying speed is smaller. That is, it can be said that the ink droplets can be ejected at a high frequency. In the evaluation result of FIG. 10, when the variation patterns of the potentials of the previous ejection pulse PSX and the evaluation target ejection pulse PSY is the same as the variation pattern of the potential of the first ejection pulse PS2a, in other words, when the first ejection pulse PS2a is continuously applied, the variation degree (the maximum amplitude) becomes 0.547. In addition, when the generation period of the first hold component h1 is longer, the variation becomes smaller. For example, when the generation period of the first hold component h1 is made longer as 0.2 μs, the variation degree becomes 0.466. When the generation period of the first hold component h1 is made longer as 0.4 μs, the variation degree becomes 0.49. Likewise, when the generation period of the first hold component h1 is made longer as 0.6 μs, the variation degree becomes 0.448. When the generation period of the first hold component h1 is made longer as 0.8 μs, the variation degree becomes 0.232. It is considered because the longer the generation period of the first hold component h1 is, the lower the ink pressure at the application start time of the contraction component d1 becomes.

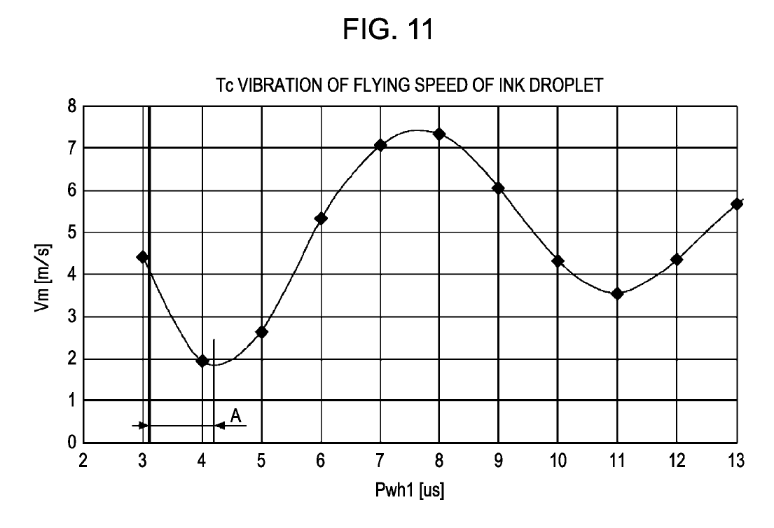

This fact can be also known from a graph shown in FIG. 11. FIG. 11 is a diagram illustrating the flying speed of the ink droplet ejected by one ejection pulse PS2. FIG. 11 shows the flying speed of the ink droplet when the generation period of the first hold component h1 is made longer gradually. In the ejection pulse PS2, the potential difference and the generation period of each of the first expansion component c1 (an excitation component) and the contraction component d1 (an ejection component) are the same as those of the first ejection pulse PS2a. Accordingly, a range indicated by A in FIG. 11 corresponds to an evaluation range of FIG. 10. In the range indicated by A, as apparent from FIG. 11, the longer the first hold component h1 is, the lower the ink pressure at the application start time of the contraction component d1 becomes. This means that the ink pressure can be prevented from becoming excessively high, as the first hold component hi is longer. In other words, this means that the variation of the flying speed of the ink droplet and the variation of a flying direction of the ink droplet can be suppressed to be stabilized.

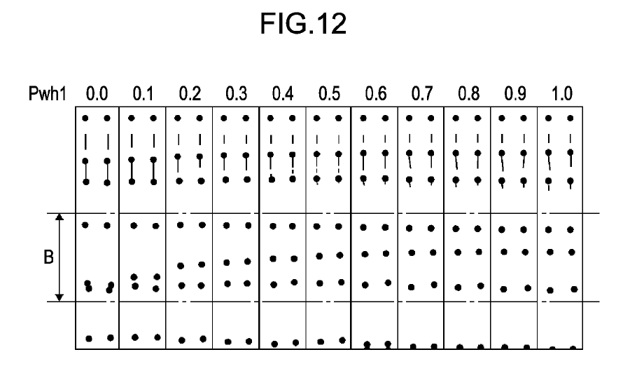

FIG. 12 is a diagram schematically illustrating flying statuses of the ink droplets formed by the previous ejection pulse PSX, the ink droplets formed by the evaluation target ejection pulse PSY, and the ink droplets formed by the subsequent ejection pulse PSZ. In FIG. 12, numerical values shown in the upper part thereof represent the generation periods of the first hold component h1 of the evaluation target ejection pulse PSY. That is, as in FIG. 10, the numerical values show the differences with the generation periods of the first ejection pulse PS2a. In addition, the interval of the previous ejection pulse PSX, the evaluation target ejection pulse PSY, and the subsequent ejection pulse PSZ is equal to the driving signal COM. Black circles within a range denoted by B represent the ink droplets ejected by the respective ejection pulses PSX, PSY, and PSZ. That is, in the range B, the black circles at the lowermost part represent the ink droplets ejected by the previous ejection pulse PSX and the black circles at the uppermost part represent the ink droplets ejected by the subsequent ejection pulse PSZ. The black circles positioned between the upper and lower black circles represent the ink droplets ejected by the evaluation target ejection pulse PSY.

As known in FIG. 12, it can be known that the flying speed of the ink droplets ejected by the evaluation target ejection pulse PSY is sufficiently higher than the flying speed of the ink droplets ejected by the previous ejection pulse PSX and can overtake the flying speed of the ink droplets ejected by the previous ejection pulse PSX, when the generation period of the first hold component h1 of the evaluation target ejection pulse PSY is the same as that of the first ejection pulse PS2a. The ink droplets ejected by the evaluation target ejection pulse PSY are delayed, as the generation period of the first hold component h1 is longer. In this example, when 0.3 μs is added, in other words, when this generation period is set so as to be longer by 10% than the generation period (3.1 μs) of the first hold component h1 of the first ejection pulse PS2a, the flying speed or the flying direction is stabilized. In the result of FIG. 12, when 0.3 μs or more is added, the flying speed or the flying direction is stabilized. However, from the point of view that the ink droplets are ejected at a high frequency, it is preferable that an addition period is 0.9 μs or less (30% or less).

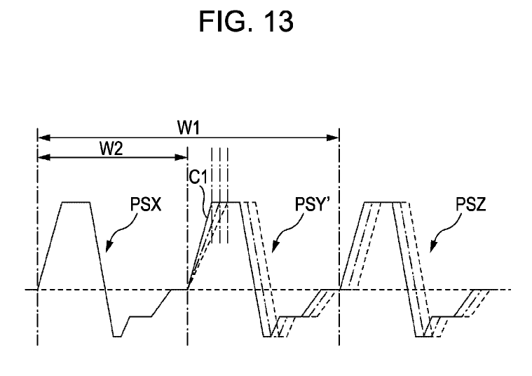

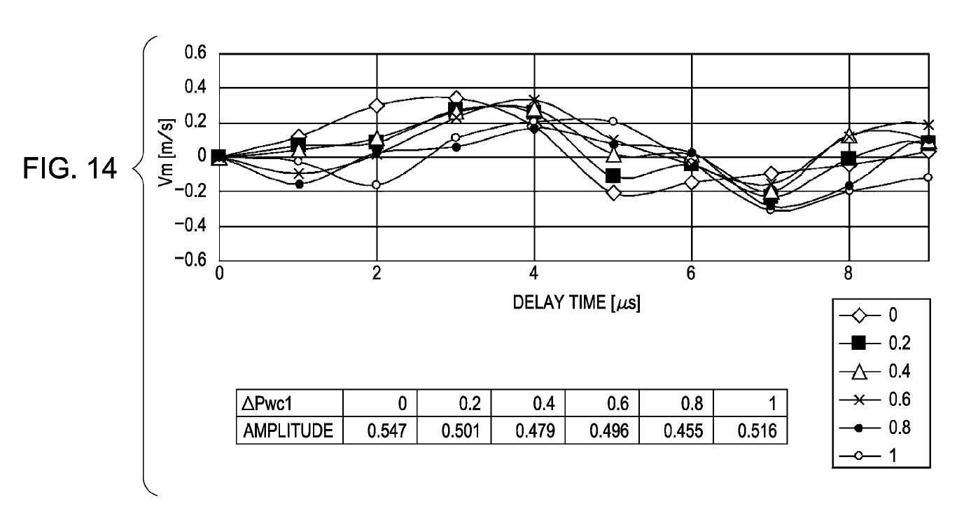

Next, an evaluation result obtained at the time of varying the generation period of the first expansion component c1 will be described with reference FIGS. 13 and 14. FIG. 13 is an explanatory diagram illustrating an ejection pulse group used for evaluation. FIG. 14 is a diagram illustrating a relation between the variation of the flying speed of the ink droplets and an interval from the second ejection pulse (the evaluation target ejection pulse PSY) to the third ejection pulse (the subsequent ejection pulse PSZ) in every kind of the second ejection pulse.

First, the ejection pulse group used for evaluation will be described. As shown in FIG. 13, the ejection pulse group is also constituted by three ejection pulses: a previous ejection pulse PSX, an evaluation target ejection pulse PSY, and a subsequent ejection pulse PSZ. Since the previous ejection pulse PSX and the subsequent ejection pulse PSZ among the ejection pulses PSX, PSY, and PSZ are the same as those of FIG. 9, the description will be omitted.

The evaluation target ejection pulse PSY has a variation pattern of the potential determined by use of the above-described first ejection pulse PS2a as a reference. In this example, as schematically illustrated in FIG. 13, a plurality of the evaluation target ejection pulses PSY obtained by making the generation period of the first expansion component c1 longer gradually are evaluation targets. Specifically, as shown in the lower part of FIG. 14, the total six evaluation target ejection pulses PSY having the same variation pattern of the potential as the variation pattern of the potential of the first ejection pulse PS2a, that is, from the evaluation target ejection pulse (ΔPwc1=0 μs), in which the generation period of the first expansion component c1 is the same as that of the first expansion component c1 of the first ejection pulse PS2a, to the evaluation target ejection pulse (ΔPwc1=1 μs), in which the generation period of the first expansion component c1 is longer than that of the first expansion component c1 of the first ejection pulse PS2a by 1 μs, are the evaluation targets. The flying speed of the ink droplet ejected by the subsequent ejection pulse PSZ is measured in each of the evaluation target ejection pulses PSY. At this time, the flying speed of the ink droplet is measured several times by allowing the interval between the evaluation target ejection pulse PSY and the subsequent ejection pulse PSZ to be longer gradually.

FIG. 14 shows the evaluation result. Here, a variation of the flying speed is also used for this evaluation. In the evaluation result of FIG. 14, when the variation patterns of the potentials of the previous ejection pulse PSX and the evaluation target ejection pulse PSY are the same as the variation pattern of the potential of the first ejection pulse PS2a, the variation degree becomes 0.547. In addition, when the generation period of the first expansion component c1 is longer, the variation becomes smaller. For example, when the generation period of the first expansion component c1 is made longer as 0.2 μs, the variation degree becomes 0.501. When the generation period of the first expansion component c1 is made longer as 0.4 μs, the variation degree becomes 0.479. Likewise, when the generation period of the first expansion component c1 is made longer as 0.6 μs, the variation degree becomes 0.496. When the generation period of the first expansion component c1 is made longer as 0.8 μs, the variation degree becomes 0.455. It is considered because the longer the first expansion component c1 is, the lower the ink pressure at the application start time of the contraction component d1 becomes.

When the evaluation result of FIG. 14 is compared to the evaluation result of FIG. 10, it is considered that the ejection of the ink droplet is stabilized by allowing the generation period of the first expansion component c1 of the evaluation target ejection pulse PSY to be longer than the generation period of the first expansion component c1 of the first ejection pulse PS2a by 0.2 μs or more. That is because in the evaluation result of FIG. 10, the variation degree is 0.513 when the generation period of the first hold component h1 is made longer than generation period of the first hold component h1 of the first ejection pulse PS2a by 1 μs or more and the ejection of the ink droplets is stabilized. In this example, since the generation period of the first expansion component c1 of the first ejection pulse PS2a is 2.7 μs, it is considered that the flying speed or the flying direction is stabilized by setting the generation period to be longer by at least 10%. From the point of view that the ink droplets are ejected at a high frequency, it is preferable that an addition period is 0.9 μs or less (⅓ or less), like the first hold component h1.

Moreover, by appropriately changing a combination of the generation periods of the first expansion component c1 and the first hold component h1 in the evaluation target ejection pulse PSY, measuring the flying speed of the ink droplets by the subsequent ejection pulse PSZ, and selecting the combination in which the variation of the flying speed is small, it is possible to optimize the variation pattern of the potential of the evaluation target ejection pulse PSY.

### SUMMARY

In this embodiment, as described above, two ink droplets (first and second liquid droplets) having the same target ejection amount are continuously ejected by continuously applying the first ejection pulse PS2a and the second ejection pulse PS2b to the piezo elements PZT. In other words, the pressure vibration is excited in the ink inside the pressure chamber 323 by applying the first expansion component c1 (the first excitation component) of the first ejection pulse PS2a to the piezo elements PZT. Subsequently, by adjusting the time by use of the first hold component h1 (the first constant potential component), the contraction component d1 (the first ejection potential component) is applied at the time when the pressure of the ink inside the pressure chamber 323 reaches the predetermined pressure. Subsequently, by applying the first expansion component c1 (the second excitation component) of the second ejection pulse PS2b to excite the ink inside the pressure chamber 323 to the pressure vibration, the time is adjusted by use of the first hold component h1 (the second constant potential component). Subsequently, the contraction component d1 (the second ejection component) is applied at certain time while the ink pressure inside the pressure chamber 323 becomes lower than the predetermined pressure. In this way, when the piezo elements PZT are expanded such that the second ink droplet is ejected, it is possible to suppress the ink pressure inside the pressure chamber 323 from becoming excessively high. In consequence, even when the ejection interval between the first and second ink droplets is made shorter, the second ink droplet can be ejected stably. Accordingly, it is possible to increase the ejection frequency of the ink droplets.

In this embodiment, the variation pattern of the potential of the evaluation target ejection pulse PSY is evaluated by use of the three ejection pulses: the previous ejection pulse PSX, the evaluation target ejection pulse PSY, and the subsequent ejection pulse PSZ. That is, the range of the variation of the flying speed of the ink droplets is evaluated by measuring the variation of the flying speed of the ink droplets ejected by the subsequent ejection pulse PSZ, while the interval is changed from the evaluation target ejection pulse PSY to the subsequent ejection pulse PSZ. By taking this evaluation method, it is possible to recognize the pressure variation of the ink inside the pressure chamber 323 after the ink droplets are ejected by the evaluation target ejection pulse PSY. Accordingly, it is possible to appropriately evaluate the evaluation target ejection pulse PSY, even when the ejection interval between the liquid droplet based on the previous ejection pulse PSX and the ink droplet based on the evaluation target ejection pulse PSY, that is, even when the ejection frequency is increased. Moreover, it is possible to optimize the variation pattern of the potential even when the evaluation target ejection pulse PSY has the variation pattern of the potential different from a certain variation pattern of the potential of the previous ejection pulse PSX.

### Other Embodiments

The above-described embodiment of the invention has been described for easy understanding of the invention and does not limit the invention. The invention can be modified and reformed without departing the gist of the invention. Of course, the equivalents of the invention are included.

In the above-described embodiment, the printer capable of ejecting aqueous ink or oily ink is used as an example of the liquid ejecting apparatus. Here, the liquid as the ejection target is not limited to aqueous ink. For example, liquids other than ink (including a liquid-like material in which particles of a functional material are dispersed and a colloidal material such as gel as well as the liquid) may be used.

For example, the liquid ejecting apparatus may be a liquid-like material ejecting apparatus ejecting a liquid-like material in which materials such as an electrode material or a coloring material used for manufacturing a liquid crystal display, an EL (electroluminescence) display, and a surface-emission display are dispersed or melted, a liquid ejecting apparatus ejecting bio organics used for manufacturing a bio chip, or a liquid ejecting apparatus used as a precise pipette to eject a liquid as a sample. In addition, the liquid ejecting apparatus may be a liquid ejecting apparatus ejecting lubricant to a precise machine such as a clock or a camera by use of a pin point, a liquid ejecting apparatus ejecting a transparent resin liquid such as a ultraviolet-curable resin onto a substrate to form a micro semi-circular lens (optical lens) used in an optical communication device, a liquid ejecting apparatus ejecting etchant such as acid or alkali to etch a substrate and the like, or a colloidal material ejecting apparatus ejecting gel.

### Ejection Pulse

In the variation pattern of the potential of the above-described ejection pulse, a potential increases from the middle potential as the reference potential to the highest potential, the potential decreases from the highest potential to the lowest potential, and then the potential increases up to the middle potential. Here, various variation patterns of the potential can be determined in the ejection pulse. For example, an ejection pulse having a variation pattern of the potential with a trapezoid wave shape or a rectangular wave shape may be used. In this ejection pulse, the potential increases from the lowest potential as a reference potential to the highest potential and then the highest potential holds for predetermined time. Then, the potential decreases up to the lowest potential. In short, the ejection pulse may include a component exciting the liquid inside a pressure chamber to pressure vibration and a component allowing an element to perform a process of ejecting liquid droplets from nozzles.

### Element Performing Process of Ejecting Liquid

In the above-described embodiment, the piezo element PZT has been described as the element for ejecting the liquid. Here, a certain piezo element PZT used in the head ejecting the liquid expands the pressure chamber as a potential is higher and a certain piezo element PZT used in the head contracts the pressure chamber as a potential is higher. The invention is applicable to both the piezo elements PZT. In addition, when the latter piezo element is used, the waveform of the ejection pulse is reversed in a height direction of the potential.

Moreover, the element is not limited to the piezo element PZT. That is, any element may be used as long as the element excites the liquid inside the pressure chamber to the pressure vibration with application of an excitation component to eject liquid droplets from nozzles with application of an ejection component. For example, a magnetostrictor may be used.

What is claimed is:

1. A liquid ejecting apparatus comprising:
pressure chambers which individually communicate with nozzles;
an element which performs a process of varying a liquid pressure inside the pressure chamber in accordance with variation in a potential; and
an ejection pulse generating unit which generates an ejection pulse having a determined variation pattern of the potential and generates a first ejection pulse applied to the element upon ejecting first liquid droplets from the nozzles and a second ejection pulse applied to the element upon ejecting second ejection droplets subsequent to the first liquid droplet from the nozzles,
wherein the first ejection pulse has a first excitation component exiting the liquid inside the pressure chamber to pressure vibration and a first ejection component generated after generation of the first excitation component and allowing the element to perform a process of ejecting liquid droplets from the nozzles at the time when the pressure of the liquid inside the pressure chamber reaches predetermined pressure, and
wherein the second ejection pulse has a second excitation component exciting the liquid inside the pressure chamber to pressure vibration and a second ejection component generated after generation of the second excitation component and allowing the element to perform the process of ejecting the liquid droplets from the nozzles at certain time while the pressure of the liquid inside the pressure chamber becomes lower than the predetermined pressure.

2. The liquid ejecting apparatus according to claim 1,
wherein the first excitation component is a component varying a potential from a reference potential to one of the highest potential and the lowest potential,
wherein the first ejection component is a component changing the potential from one of the highest potential and the lowest potential to the other thereof,
wherein the second excitation component is a component varying the potential from the reference potential to one of the highest potential and the lowest potential, and
wherein the second ejection component is a component changing potential from one of the highest potential and the lowest potential to the other thereof.

3. The liquid ejecting apparatus according to claim 1, wherein a variation amount of the potential per unit time in the second excitation component is smaller than a variation amount of the potential per unit time in the first excitation component.

4. The liquid ejecting apparatus according to claim 1,
wherein the first ejection pulse has a first constant potential component connecting an end point of the first excitation component to a start point of the first ejection component with constant potential, and
wherein the second ejection pulse has a second constant potential component connecting an end point of the second excitation component to a start point of the second ejection component with constant potential and a generation period of the second constant potential component is longer than a generation period of the first constant potential component.

5. The liquid ejecting apparatus according to claim 2,
wherein the first ejection pulse has a first return portion which is generated after the generation of the first ejection component and restrains a pressure variation of the liquid inside the pressure chamber by returning the potential from the other of the highest potential and the lowest potential to the reference potential, and
wherein the second ejection pulse has a second return portion which is generated after the generation of the second ejection component and restrain a pressure variation of the liquid inside the pressure chamber by returning the potential to the other of the highest potential and the lowest potential to the reference potential.

6. The liquid ejecting apparatus according to claim 5, wherein a variation pattern of the potential of the second return portion is the same as a variation pattern of the potential of the first return portion.

7. The liquid ejecting apparatus according to claim 1, wherein the element is deformed in accordance with a potential determined by the first and second ejection pulses to change a volume of the pressure chamber.

8. A liquid ejecting method comprising:
exciting a liquid inside a pressure chamber to pressure vibration by applying a first excitation component to an element which performs a process of varying a liquid pressure inside the pressure chamber in accordance with variation in a potential;
allowing the element to perform a process of ejecting liquid droplets from nozzles individually communicating with the pressure chambers by applying a first ejection component to the element after the application of the first excitation component to the element at the time when a pressure of the liquid inside the pressure chamber reaches a predetermined pressure;
exciting the liquid inside the pressure chamber to pressure vibration by applying a second excitation component to the element after the liquid droplets are ejected from the nozzles; and
allowing the element to perform the process of ejecting the liquid droplets from the nozzles by applying a second ejection component to the element after the application of the second excitation component at certain time while the pressure of the liquid inside the pressure chamber becomes lower than the predetermined pressure.
